(19) United States
(12) Patent Application Publication
(10) Pub. No.: US 2008/0262971 A1
(43) Pub. Date: Oct. 23, 2008

(54) DEVICE, SYSTEM AND COMPUTER WRITEABLE MEDIA FOR ACCOMPLISHING REAL TIME DOWNLOADING OF TRANSACTIONAL INFORMATION TO A PERSONAL DIGITAL ASSISTANT, INCLUDING REMOTE SERVER INCORPORATING PERSONAL ASSISTANT MANAGER SOFTWARE

(76) Inventors: Janette B. Davis, Birmingham, MI (US); Brian R. F. Davis, Birmingham, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/736,895

(22) Filed: Apr. 18, 2007

(51) Int. Cl. H04L 9/00

(52) U.S. Cl. 705/75

(57) ABSTRACT

A user operated device, operating system and associated computer writeable media for retrieving, storing and displaying data associated with at least one personal financial account. A handheld body includes a built in microprocessor and memory communicating with a keypad, screen display and power supply. A built-in modem and wireless communication protocol associated with said processor soliciting the retrieving and downloading of digital information, in real-time fashion from a remote server (including such as a Personal Assistant Manager subscription based server for compiling, storing and regularly updating transactional information relating to each of a plurality of unrelated user accounts), said transmitted information being selectively stored into said memory and/or presented on said screen display.

### BACKGROUND OF THE INVENTION

1. Field of the Invention

The present invention relates generally to software supported and real time updateable devices and associated computer writeable media for enabling individuals and businesses to organize finances and track both expenses and revenue. More specifically, the present invention discloses a handheld, wireless, electronic, personal check/credit card balancing device which is particularly suited for tracking all personal financial data of a user. An associated software component, such as is termed Personal Account Manager, operates as a remote network server and which enables a user to retrieve, in real time fashion, updated account information on all accounts with one password in one transmission.

2. Description of the Prior Art

The prior art is well documented with various examples of check and transactional processing systems and associated software. The objective in each instance is to provide accurate accountability of transaction information, such as relating to credit cards accounts, personal checking accounts, money market accounts and the like.

U.S. Patent Application Publication No. 2003/0037002, Higgins et al., teaches a method of operating an electronic check presentment with image interchange system and including the steps of creating a number of electronic bundle files based upon captured MICR data associated with items, processing cash letter files and captured image data associated with the items to create a first temporary list. Additional steps include processing the cash letter files and electronic bundle files to create a second temporary list, and merging the first and second temporary lists to create a merged list for creating an image presentment file, this further being created in a predefined format structure suitable for sending from a sending back to a receiving bank based upon the merged list.

U.S. Patent Application Publication No. 2003/0187790, Swift et al., teaches a transaction processing system for merchants designed to convert the presentation of any payment device or technology into electronic debits from a checking account. Such payment device can include a transponder, a loyalty card, one or more smart cards, a computing device, a personal digital assistant, a wireless telephone, one or more biometric elements, and one or more devices using biometric information.

U.S. Pat. No. 5,832,464, to Houvener et al., teaches a device and method for facilitating signature-less financial transactions as an improvement over common, prior art check-based financial transactions. The system and method provides the ability to use a check as a form of payment at a point of use without having to use the signed check as the binding document that is processed through the financial system to obtain payment by the entity rendering the service. The system and method also reads a hardcopy check via an electronic scanner, correlating the account number to a biometric or other piece of data for positively identifying the person tendering the check. The data is then associated with an auditable record of the person who performed the biometric or other data comparison. Once a particular financial transaction is authorized, the check is returned to the tenderer and the financial transaction is processed as an electronic fund transfer (EFT).

U.S. Pat. No. 5,233,547, issued to Kapp, discloses an electronic checkbook and method for using it. The checkbook includes upper and lower foldable parts, the lower part receiving on its upper surface a booklet of checks. A digitizer is hingedly connected or fixed to the remainder of the lower part and operates as a keyboard in one mode when placed above the check booklet, and can be placed beneath the top check of the booklet and use in a second mode as a means for inputting signals to the remainder of the device representing information written on the checks. The lower part of the checkbook also includes other elements of the device representing information written on the check. The lower part of the checkbook also includes other elements of the device such as a microprocessor, a power supply and a smart card reader/writer. The upper part includes a display screen upon which checking account information appears during use of the electronic checkbook. The method of use of the checkbook provides maintenance of a record of transaction in the account, including addition of deposits and subtraction of checks drawn on the account.

Finally, another example of an electronic checkbook device with printing capabilities is set forth in U.S. Pat. No. 5,475,403, issued to Havlovick et al., and which includes an electronic checkbook of a hand-held size and which operates on two AAA batteries. An on/off switch includes a needle valve which controls ink flow. A print cap switch is also provided for rugged applications. Checks are advanced wider a printhead which, in cooperation with a roller shaft, are operated by a single motor and associated transmission element. The position of the motor and printhead are sensed by use of a single LED and photo-detector. Of note, data is stored in a non-volatile check register and reconciliation of transactional information can be made by reference to information stored on a statement strip.

### SUMMARY OF THE PRESENT INVENTION

The present invention relates generally to software supported and real time updateable devices and associated computer writeable media for enabling individuals and businesses to organize finances and track both expenses and revenue. More specifically, the present invention discloses a handheld, wireless, electronic, personal check/credit card balancing device which is particularly suited for tracking all personal financial data of a user.

The device includes a built in microprocessor and memory communicating with a keypad, screen display and power supply. The devices includes a built-in modem and wireless communication protocol for soliciting and retrieving account information from a remote network server.

The network server according to one variant includes an associated software component, such as is termed Personal Account Manager, and enables a user to retrieve, in real time and wireless downloadable fashion, updated account information on all accounts with one password in one transmission. In a preferred embodiment, the Personal Account Manager operates as a subscription service, capable of compiling, storing and regularly updating transactional information relating to each of a plurality of unrelated user accounts.

The present invention provides a user with the ability to organize his or her finances and keep track of expenses and revenues. The present device and associated system and method further helps users to avoid costly fees and accommodates all consumers who are active and need quick and simple access to information.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of an electronic and hand-held personal digital assistant (PDA) forming a component of the present invention, and including an optional and communicating magnetic swipe card reader;

FIG. 2 is a first protocol scheme for accomplishing wireless activation and retrieval to the PDA of information from an account manager/banking institution;

FIG. 3 is a second protocol scheme for accomplishing wireless activation and retrieval of all user account information to the PDA, from a remote located and software based server (Personal Account Manager); and

FIG. 4 is an alternate variant to that illustrated in FIG. 2 and showing an optional swipe card function for accomplishing wireless activation and retrieval to the PDA of information from the account manager/banking institution, typically in discrete fashion per card and based upon PIN access.

### DETAILED DESCRIPTION OF THE PREFERRED EMBODIMENTS

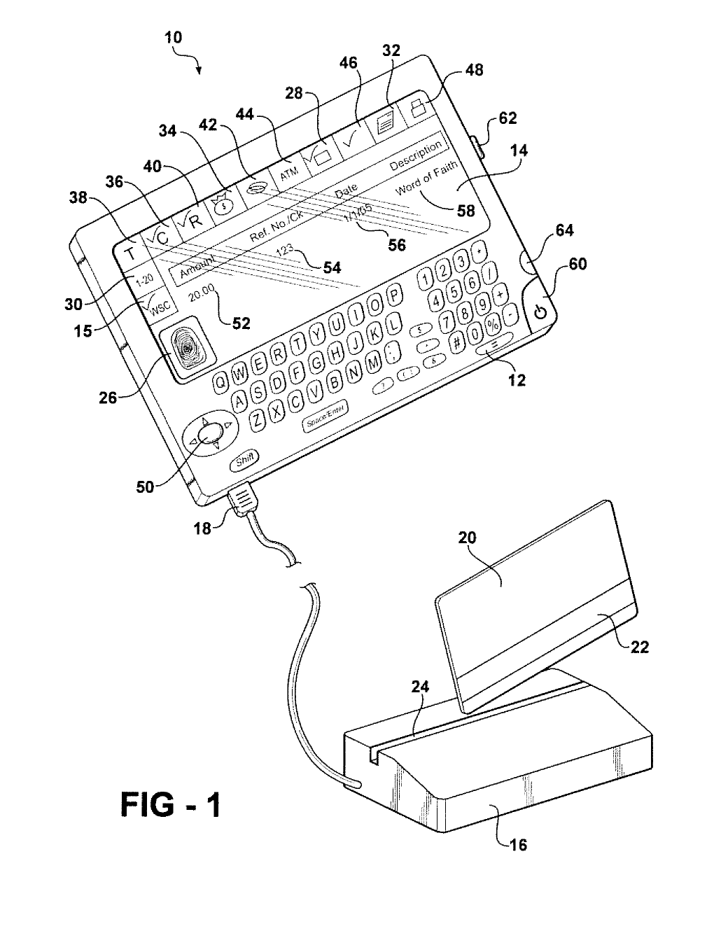

Referring to FIG. 1, the present invention generally references at 10 a user operated device for retrieving, storing and displaying data associated with at least one personal financial account. As will be described in additional detail, the present invention includes a device, system and associated computer writeable media for enabling individuals and businesses to organize finances and track both expenses and revenue.

Referring again to FIG. 1, the user operated device 10 is again illustrated for retrieving, storing and displaying data associated with at least one personal financial account. The device, uniquely configured and featured in the manner to be subsequently described, is generally provided as a personal digital assistant (PDA) like article and includes a handheld body which, according to one non-limiting variant, exhibits a 4″×2″ rectangular shape with a selected thickness. In reference to the system and computer writeable media aspects of the present invention, as will be further described, it is further understood that the features of the device 10 can constitute, in one or more alternate variants, a desktop or laptop style computer within the overall scope of those related applications.

The device 10 includes a built in microprocessor and memory communicating (these features not specifically illustrated in the article of FIG. 1 but understood to be incorporated into the construction and internal processing capabilities of the device). Additional features include an alpha/numeric keypad 12 (with symbols), screen display 14 and power supply (not shown but understood to includes such as a battery or power cord attachment) for powering the various components of the device.

The device further includes, in association with its internal processing capabilities, a built-in modem and a wireless communication protocol for soliciting the retrieving and downloading of digital information, in real-time fashion from a remote server, and for selectively storing said information into said memory and presenting said information on the screen display 14. In one variant, a direct wireless activation key, such as associated with the keypad 12 or a touch screen location associated with the display 14, can be activated for initiating retrieval of desired transactional information, on a real-time basis, from a remote server (as will be subsequently described). Screen display icon 15 in FIG. 1 illustrates a wireless smart connection indicator for signaling when wireless communication is established with a remote server. Although not shown, a wireless connection card is typically engaged with an associated card portal, and in a manner generally known in the relevant technical art.

In such a variant, account identification information (i.e. account number, password information and the like) relating to any of a checking, debit, credit card or other money market account can be preprogrammed into the memory of the device 10 and which is cooperates with the wireless activation key and smart connection software incorporated into the device for requesting automatic download of up to date account information from the remote server. As will be further described in reference to the subsequent system and computer writeable media applications of the present invention, such encryption/decryption protocol associated with the wireless communication protocol and microprocessor can further provide secure wireless transmission through the encoding and decoding of information.

In a further possible variant, a magnetic card reader, shown as a USB plug in attachment at 16, is operatively communicated (see plug 18) with the device and operates in the alternative of depressing a direct wireless activation (“checkNow”) key, such as again associated with the keypad or touch screen features of the device 10. A further sub-variant of this application contemplates the features of the card reader incorporated directly into the software/hardware construction of the device 10.

Upon swiping a selected card 20 into the reader 16, and in particular linearly translating its magnetic strip 22 along a passageway 24 defined in the key card reader of a known construction, a wireless activation/retrieval request is initiated for receiving real time and downloadable information from the remote server. This variant also contemplates the ability to retrieve, display and store account information, in sequential fashion, on the device, and such as through the additional input of a pin number into the keypad 12 or a biometric input, such as represented by a thumbprint touchpad location 26 associated with screen 14.

Additional screen illustrated features (or icons) associated with device 10, these operating in cooperation with the microprocessor and associated control protocol of the device, include such features as manual check writing 28, maximum account tracking 30, review capability 32, deposit tally 34, cleared checks 36, account balance information 38, NSF (insufficient funds) indication 40, account type (Debit/Credit) 42, electronic transfer indicator 44, check clear inquiry 46 and infrared (e.g. wireless/BlueTooth®) printer connection 48. The screen icons referenced herein can operate in cooperation with the keypad features (see in particular directional keypad 50). Alternatively, a touch screen depressible stylus or pen (not shown) can be employed for electing a specified control function.

By example, the screen display 14 in FIG. 1 illustrates a selected transaction indicated as a $20.00 payment (52), referenced as check No. 123 (at 54), posted on Jan. 1, 2005 (at 56) and payable to Word of Faith (58). It is further understood that each of the screen icon displays, when actuated, varies the information content of the screen display, this usually further being represented in an LCD or like fashion. Yet additional hardware features associated with the device also include an on/off button 60 in communication with the power supply (e.g. internal battery and/or AC/DC cord adaptor). A power/reset button is also referenced at 62, as well as an LED indicator button and which, when depressed, can backlight the screen 14 to provide illuminated viewing, such as in a darkened room our outdoors at night.

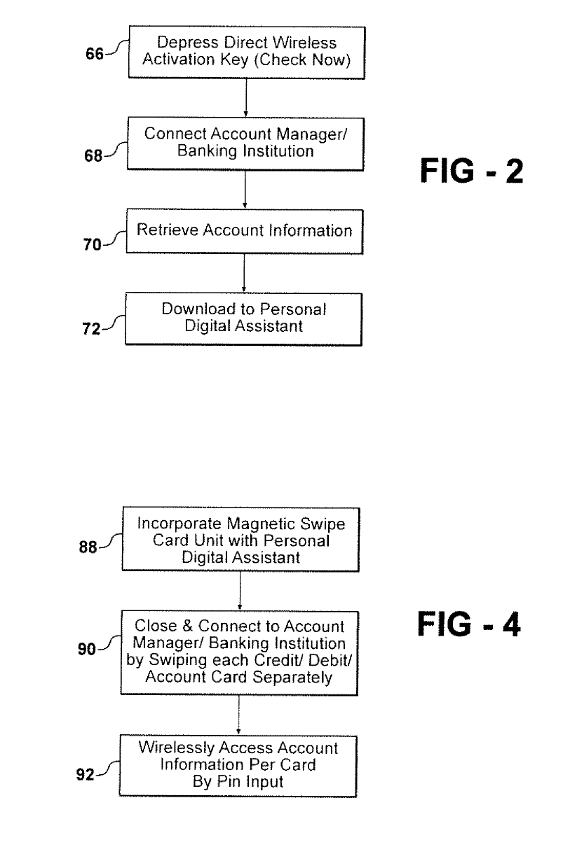

Having provided a general description of the operating features associated with the personal electronic device 10, a further explanation will now be made to the features of the remote server defining a component of the system for accomplishing real time wireless downloading of transactional information pertaining to at least one user-accessible account. In particular, and in a first application as defined in the protocol scheme of FIG. 2, wireless activation and retrieval to the PDA of information from an account manager/banking institution is initiated by depressing a key generally identified at step 66. At step 68, the wireless smart connection (see also at 15 in FIG. 1) connect to a wireless managed account associated with a given and existing account manager/banking institution (e.g. bank, credit card issuer, market fund, etc.) At step 70, the desired account information (i.e. all of the up to date transactions associated with that specified account and which is typically serviced by the provider operating the remote server) is wirelessly transmitted to the device 10 for downloading, presenting and/or storing the same in real time.

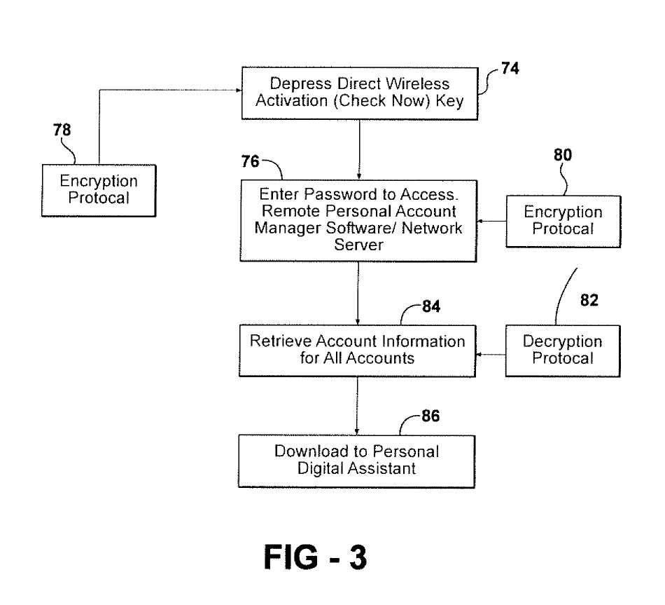

Referring further to FIG. 3, a second protocol scheme is depicted for accomplishing wireless activation and retrieval of all user account information to the PDA, and from a remote located and software based server (Personal Account Manager). In particular, step 74 repeats that shown at 66 in FIG. 2, and by which a user depresses a direct wireless activation key (CheckNow), or alternatively uses a stylus/pen to activate a press screen icon.

Proceeding further to step 76, a remote server associated with this embodiment further includes a dedicated subscription based server, this incorporating, in one user and wireless accessible account, any plurality of individual accounts associated with a user and selected from at least one of a bank account, credit card issuer, investment account and financial tracking institution. This subscription service, also defined as a Personal Account Manager (PAM), further operates as a central clearing house servicing the user operated device 10, again via wireless accessible account, and in order to transmit information relating to all personal accounts.

The nature of the multiple accounts which the PAM server can track includes such as any bank checking/debit account, any credit card issued account, as well as an liquidity fund/market account. A further advantage of the PAM server is the ability to compile up to date and real time transactional information relating to all of these disparate accounts in one wirelessly accessible and updateable server for continuous and iterative updating fashion.

Although previously discussed, such additional protocol features as a biometric (e.g. finger/thumb print, retinal scan, etc.) input 78 can operate as a prerequisite step to the wireless request 74 originating from the personal (PDA) device 10. The PAM network server can also incorporate an encryption scheme or protocol (see at 80) to more safely transmit the account transaction information in wireless fashion, the device further incorporating an associated decryption scheme or protocol 82 in use with its downloading functionality (see retrieve account information for all accounts 84) and which results in the transactional information be downloaded, at step 86, in digital fashion for selective presentation or storage.

Referring finally to FIG. 4, is an alternate variant to that illustrated in FIG. 2 and illustrating a yet further protocol of the optional swipe card function for accomplishing wireless activation and retrieval to the PDA of information from the account manager/banking institution, typically in discrete fashion per card and based upon PIN access. In particular, step 88 illustrates the incorporation of the magnetic card reader in operative communication with the user operated device.

Upon swiping a selected card into the reader, step 90, wireless retrieval (transmission) and downloading of the real time information from the remote server is initiated (again either a dedicated server associated with a checking/debit/credit card/money market account or a PAM subscription account compiling up to date information on a number of different user accounts selected from the above). As also shown at 92, a PIN (personal identification) number may be key entered into the device 10, such as corresponding with the magnetic swipe card function, and in order to authenticate and order the retrieval of information sent wirelessly (e.g. such as again in encrypted fashion) to the hand held device 10.

As also described previously, the system may also contemplate substituting the electronic device illustrated in FIG. 1 with an existing desktop or laptop/notebook style computer, this providing substantially all of the processor requirements as well as software/hardware protocol previously described. In particular, the device 10 can be substituted in this embodiment by a software based program downloaded into an existing computer, ideally a portable laptop computer, into which is incorporated a wireless connection card for real time download/retrieval and storage/display of such account specific transactional information.

A further sub-embodiment of the invention contemplates the provision of a computer writeable media for providing real time wireless downloading of information associated with personal financial accounts. This includes such as a first subroutine for compiling, storing and regularly updating transactional information relating to each of a plurality of unrelated user accounts.

A second subroutine is provided for authenticating a wireless inputted user request to transmit transactional information and a third subroutine, which is conditional upon satisfactory compliance with the second subroutine, provides for transmitting, in likewise wireless and real time fashion, the desired transactional information for download, display and storage on a processor driven device, such as again including the PDA style device of FIG. 1 as well as any other processor driven device possessing the basic hardware/software requirements for wirelessly downloading, presenting and/or storing/compiling the transactional information in a digital format and in the manner desired.

It is further envisioned that the computer writeable media can incorporate discrete pieces of software, or programs, associated with each of the remote/PAM server and downloadable device. Furthermore, any of a myriad of software programs and/or codes can be generated for accomplishing the basic functionality requirements disclosed herein and in reference to both the remote server and/or handheld device.

Having described our invention, other and additional preferred embodiments will become apparent to those skilled in the art to which it pertains and without deviating from the scope of the appended claims:

We claim:

1. A user operated device for retrieving, storing and displaying data associated with at least one personal financial account, said device comprising:
a handheld body including a built in microprocessor and memory communicating with a keypad, screen display and power supply; and
said body further including a built-in modem, a wireless communication protocol associated with said built in processor soliciting the retrieving and downloading of digital information, in real-time fashion from a remote server, and for selectively storing said information into said memory and presenting said information on said screen display.

2. The device as described in claim 1, further comprising a direct wireless activation key associated with said body for initiating retrieval of said information from said remote server.

3. The device as described in claim 1, further comprising a magnetic card reader in operative communication with said device and, upon swiping a selected card into said reader, initiating retrieval of said information from said remote server.

4. The device as described in claim 1, said device exhibiting a specified shape and size, said remote server being associated with at least one of a bank account, credit card issuer, investment account and a financial tracking institution.

5. The device as described in claim 4, said remote server further comprising a dedicated subscription based server incorporating, in one user and wireless accessible account, any plurality of individual accounts associated with a user.

6. The device as described in claim 1, said device having a specified shape and size and further comprising a biometric input parameter for enabling said wireless communication software.

7. The device as described in claim 6, said biometric input parameter further comprising at least one of a finger and thumb print reader communicating with said device.

8. The device as described in claim 1, further comprising an encryption/decryption protocol associated with said wireless communication protocol and microprocessor for providing secure wireless transmission and decoding of said information.

9. The device as described in claim 1, said body having a generally rectangular shape with a selected thickness and including additional screen accessible features associated with said microprocessor and including at least one of manual check writing, maximum account tracking, review capability, deposit tally, clear checks, fees incurred, check returns, and print out capability.

10. The device as described in claim 1, said body further comprising an on/off button in communication with said power supply and microprocessor, said wireless communication protocol further comprising a wireless connection card with card portal.

11. A system for accomplishing real time wireless downloading of transactional information pertaining to at least one user-accessible account, comprising:
a user operated device including a built in processor and memory which communicates with an interactive keypad and screen display, said body further comprising a built-in modem and wireless communication protocol associated with said processor; and
a remote server containing transactional information relating to at least one user account, said server responding to said wireless communication protocol to download to said device, in real time, the transactional information.

12. The system as described in claim 11, said remote server further comprising a dedicated subscription based server incorporating, in one user and wireless accessible account, any plurality of individual accounts associated with a user and selected from at least one of a bank account, credit card issuer, investment account and financial tracking institution.

13. The system as described in claim 12, said subscription based server further comprising a central clearing house servicing said user operated device, via said wireless accessible account, upon depressing a wireless activation button associated with said device, said server transmitting information relating to all personal accounts.

14. The system as described in claim 11, further comprising a magnetic card reader in operative communication with said user operated device and, upon swiping a selected card into said reader, initiating retrieval of said information from said remote server.

15. The system as described in claim 11, said device having a specified shape and size and further comprising a biometric input parameter for enabling said wireless communication software.

16. The system as described in claim 15, said biometric input parameter further comprising at least one of a finger and thumb print reader communicating with said device.

17. The system as described in claim 11, further comprising an encryption/decryption protocol associated with said wireless communication protocol and microprocessor for providing secure wireless transmission and decoding of said information.

18. The system as described in claim 11, said body having a generally rectangular shape with a selected thickness and including additional screen accessible features associated with said microprocessor and including at least one of manual check writing, maximum account tracking, review capability, deposit tally, clear checks, fees incurred, check returns, and print out capability.

19. The system as described in claim 11, said body further comprising an on/off button in communication with said power supply and microprocessor, said wireless communication protocol further comprising a wireless connection card with card portal.

20. A computer writeable media for providing real time wireless downloading of information associated with personal financial accounts, comprising:
a first subroutine for compiling, storing and regularly updating transactional information relating to each of a plurality of unrelated user accounts;
a second subroutine for authenticating a wireless inputted user request to transmit transactional information; and
a third subroutine which is conditional upon said second subroutine for transmitting, in likewise wireless and real time fashion, said transactional information for download, display and storage on a processor driven device.
